(19) United States
(12) Patent Application Publication
(10) Pub. No.: US 2023/0419326 A1
(43) Pub. Date: Dec. 28, 2023

(54) SECURITY DETECTION FOR BLOCKCHAINS

(71) Applicant: Ancilia, Inc., Los Gatos, CA (US)

(72) Inventors: Huagang Xie, Los Gatos, CA (US); Wei Xu, Cupertino, CA (US)

(21) Appl. No.: 18/214,257

(22) Filed: Jun. 26, 2023

Related U.S. Application Data
(60) Provisional application No. 63/356,381, filed on Jun. 28, 2022.

(51) Int. Cl. G06Q 20/40; G06Q 20/38; G06Q 20/02

(52) U.S. Cl. CPC G06Q 20/4016; G06Q 20/02; G06Q 20/3825

(57) ABSTRACT

Techniques for security detection in blockchains are disclosed. In some embodiments, a system/process/computer program product for security detection in blockchains includes monitoring a plurality of transactions on a blockchain; generating a risk score for each of the plurality of transactions; and sending an alert if a risk score for at least one of the plurality of transactions is below a threshold.

### CROSS REFERENCE TO OTHER APPLICATIONS

This application claims priority to U.S. Provisional Patent Application No. 63/356,381 entitled SECURITY DETECTION FOR BLOCKCHAINS filed Jun. 28, 2022 which is incorporated herein by reference for all purposes.

### BACKGROUND OF THE INVENTION

A blockchain generally refers to a growing list of records called blocks. Blockchains are typically managed using a peer-to-peer network that can be used as a publicly distributed ledger. The nodes of the peer-to-peer network collectively adhere to a protocol to communicate and to validate new blocks.

The blocks of a blockchain are generally linked together using cryptography. Each block typically contains a cryptographic hash of the previous block, a timestamp, and associated transaction data (e.g., typically implemented as a tree, such as a Merkle tree, in which data nodes are represented by leaves). The timestamp can be used to prove that the transaction data existed when the block was published to get into its hash.

As blocks each contain information about the previous block, they form a chain. Each additional block generally reinforces the previous blocks in the chain. As such, blockchains are typically resistant to modification of their data, because once recorded, the data in any given block cannot be altered retroactively without altering all subsequent blocks (e.g., however, forks can occur in a chain).

### BRIEF DESCRIPTION OF THE DRAWINGS

Various embodiments of the invention are disclosed in the following detailed description and the accompanying drawings.

FIG. 1 is a block diagram of an architecture of a threat prevention platform for security detection for blockchains in accordance with some embodiments.

FIG. 2 is another block diagram of an architecture of a threat prevention platform for security detection for blockchains in accordance with some embodiments.

FIG. 3A is pseudocode of an example workflow for an API service for security detection for blockchains in accordance with some embodiments.

FIG. 3B is pseudocode for an integration into Smart Contract source code in accordance with some embodiments.

FIG. 3C is pseudocode for a customer setup detection policy (via a Dashboard) in accordance with some embodiments.

FIG. 3D is pseudocode for the Detector to perform an action based on a blockchain security detection policy in accordance with some embodiments.

FIG. 4 is a flow diagram of a process for security detection for blockchains in accordance with some embodiments.

FIG. 5 is another flow diagram of a process for security detection for blockchains in accordance with some embodiments.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

A blockchain generally refers to a growing list of records called blocks. Blockchains are typically managed using a peer-to-peer network that can be used as a publicly distributed ledger. The nodes of the peer-to-peer network collectively adhere to a protocol to communicate and to validate new blocks.

The blocks of a blockchain are generally linked together using cryptography. Each block typically contains a cryptographic hash of the previous block, a timestamp, and associated transaction data (e.g., typically implemented as a tree, such as a Merkle tree, in which data nodes are represented by leaves). The timestamp can be used to prove that the transaction data existed when the block was published to get into its hash.

As blocks each contain information about the previous block, they form a chain. Each additional block generally reinforces the previous blocks in the chain. As such, blockchains are typically resistant to modification of their data, because once recorded, the data in any given block cannot be altered retroactively without altering all subsequent blocks (e.g., however, forks can occur in a chain).

Overview of Techniques for Security Detection for Blockchains

However, technical security challenges with blockchains exist.

For example, solutions are needed for automatically detecting threats on block chains (e.g., including transactions on the blocks to, for example, enhance security for smart contracts).

Existing security solutions are inadequate and are generally focused on pen testing/security audits of the programming code for different blockchain implementations.

Moreover, current smart contract (SC) protection largely depends on manual code analysis, also known as auditing, the goal of which is to identify vulnerabilities in smart contract code before deployment and fix any identified issues in the smart contract code. However, this has primarily been a manual effort. As a result, such existing approaches are inadequate for several reasons, including, for example, the following: (1) it is not scalable; and (2) the quality of the audit work is typically not consistent, as such largely depends on the experience of the human analyzer.

There are existing tools that can facilitate the process of manual code analysis, including fuzzing tools, SAT tools, etc. These tools can facilitate some aspects of the analysis, such as identifying known vulnerability patterns in a smart contract. However, these tools generally cannot increase the protection capability provided by the manual code analysis approach.

As such, what are needed are new and improved security techniques for security detection for blockchains.

Accordingly, new and improved security techniques for security detection for blockchains are disclosed.

In some embodiments, a system/process/computer program product for security detection in blockchains includes monitoring a plurality of transactions (e.g., smart contract transactions) on a blockchain; generating a risk score for each of the plurality of transactions; and sending an alert if a risk score for at least one of the plurality of transactions is below a threshold (e.g., based on a blockchain security policy).

In one embodiment, a system/process/computer program product for security detection for blockchains further includes detecting a malicious transaction on the blockchain.

In one embodiment, a system/process/computer program product for security detection for blockchains further includes detecting a malicious transaction on the blockchain based on a signature match.

In one embodiment, a system/process/computer program product for security detection for blockchains further includes detecting a malicious transaction on the blockchain based on a heuristic match.

In one embodiment, a system/process/computer program product for security detection for blockchains further includes detecting a malicious transaction on the blockchain based on a machine learning (ML) model.

In one embodiment, a system/process/computer program product for security detection for blockchains further includes generating an alert for a smart contract transaction based on the risk score for the smart contract transaction and a blockchain security policy.

In one embodiment, a system/process/computer program product for security detection for blockchains further includes reverting a smart contract transaction based on a score for the smart contract transaction and a blockchain security policy.

For example, the disclosed techniques include providing a threat prevention platform for blockchains as will be further described below with respect to various embodiments.

In an example implementation, a threat prevention platform for blockchains provides runtime security protection for blockchains. Specifically, we can understand and extract expected behavior of a given smart contract. More specifically, we can generate a machine learning (ML) model that can automatically map a given smart contract to a set of expected behaviors (e.g., using clustering or other machine learning techniques (MLT), such as will be further described below). As more smart contract's expected behavior is analyzed and understood (manually), the ML model for smart contract behavior will increase in accuracy and coverage over time.

In this example implementation, we can apply the expected behaviors in a runtime detection system using the threat prevention platform (e.g., in the form of a smart contract (SC) profile that can be programmatically provided as input to the runtime detection system) that will compare any transaction (Tx) against the expected behaviors and identify any suspicious/malicious Tx. Any runtime-identified deviations from an SC's expected behavior can also be provided back into the ML model for smart contract behavior (e.g., and, in some cases, manual analysis can also be performed) to further improve the accuracy of the ML model for smart contract behavior.

For example, the disclosed techniques for security detection for blockchains can be implemented to automatically monitor smart contracts for a QUBIT Blockchain® (e.g., and/or other publicly/commercially available blockchains). In this example, the ML model for smart contract behavior can be trained for all interactions with their smart contracts for the QUBIT Blockchain® to learn normal behaviors/interactions with their smart contracts to generate/train the ML model for smart contract behavior to learn expected input to such contracts. The generated/trained ML model for smart contract behavior can then be deployed in the threat prevention platform for blockchains to automatically detect anomalous behavior associated with smart contracts for the QUBIT Blockchain®. In addition, heuristics can also be implemented in the threat prevention platform for blockchains to further enhance security detection for blockchains based on such smart contract transactions (e.g., input anomaly detection in terms of size, form, or increase in interaction with these functions, as well as the result after interaction with this function, which typically succeeds or fails repeatedly; or outcome/output is different than expected for typical input such as a drain of coin pool, etc.).

The disclosed techniques for security detection for blockchains can be deployed using various distinct customer consumption models. For example, the disclosed techniques for security detection for blockchains can be deployed as a service, such as a subscription service model. As another example, the disclosed techniques for security detection for blockchains can be deployed as an API service, such as an API service that provides reputation of a given entity (e.g., an entity associated with a potential smart contract transaction, in which an entity type can include an Address (EOA/Contract), Tx (KYT), etc.). These services can provide, for example, a risk score associated with a given transaction and/or entity, scoring contextual information, score change notifications, etc.

These and other embodiments and examples for security detection for blockchains will be further described below.

Example System Architectures for Security Detection for Blockchains

Accordingly, in some embodiments, the disclosed techniques include providing a security detection for blockchains as will now be further described with respect to various system embodiments.

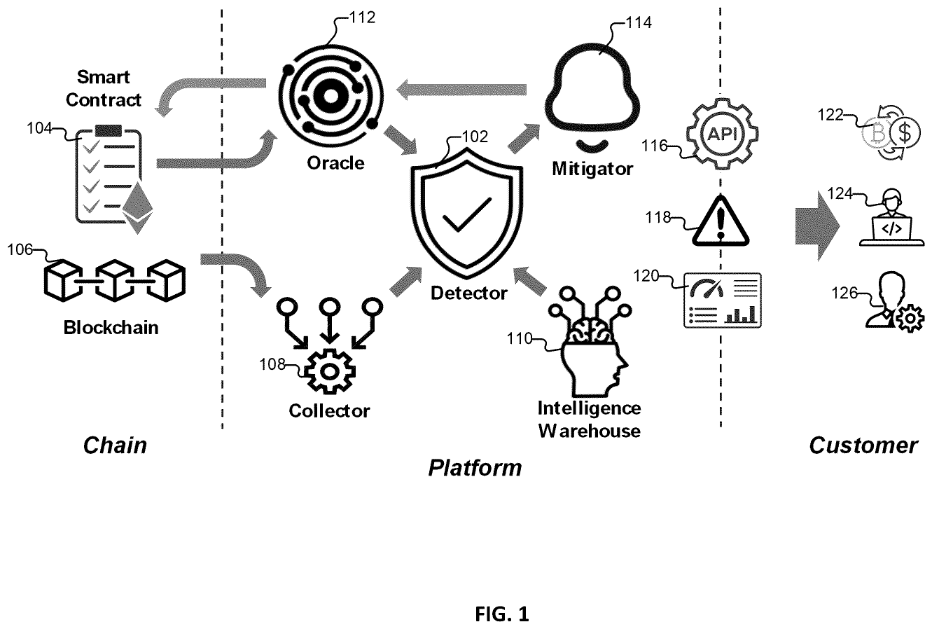

FIG. 1 is a block diagram of an architecture of a threat prevention platform for security detection for blockchains in accordance with some embodiments. While the disclosed threat prevention platform for security detection for blockchains can be applied to various implementations of blockchain technology (e.g., Bitcoin, Ethereum, QUBIT Blockchain®, and/or other publicly/commercially available blockchains), the below described embodiment is described in the context of an Ethereum blockchain implementation.

Referring to FIG. 1, a Smart Contract 104 is in communication with an Oracle service 112. The Smart Contract(s) are for transactions for a Blockchain 106. The threat prevention platform includes a Detector component 102, a Collector component 108, an Intelligence Warehouse component 110, a Mitigator component 114, and customer/user-facing component(s) that can include an API service component 116, an Alerting service component 118, and a user interface (e.g., a Dashboard that can be implemented as a graphical user interface (GUI)) 120 for interactions/communications with users/entities as shown at 122, 124, and 126 in FIG. 1. Each of these components will be further described below.

Oracle Service

The Oracle service provides an immediate-read Oracle for this example Blockchain. Specifically, the Oracle service provides info from off-chain (e.g., by storing such information in the Oracle contract's storage). An example mapping for such storage is illustrated below.
Info 1: mapping(addr=>uint) addr_scores;
Info 2: mapping(addr=>user_policy) user_policy;

The Oracle service can also include an updater service. Specifically, the updater service can update the Oracle contract's storage with latest Info[1,2] as shown above.

The Detector is in communication with the Oracle service. In an example implementation, the Detector can communicate with the Oracle service using a Request-response Oracle service (e.g., blockchain Dapps can utilize the Request-response Oracle, the response to which would be another Tx).

Collector

The Collector collects data from on-chain/offchain of the Blockchain.

In an example implementation, the following is example input data for the Collector: an API URL; an API KEY; a monitored contract address; a coin address; and/or a price Oracle address.

In this example implementation, the following is example data that is collected by the Collector: Ethereum block data, and transaction; Ethereum block balance of a monitored address for a different Coin (e.g., WETH, WBTC, etc.); Ethereum internal transactions; and/or an Ethereum internal call trace.

In an example implementation, output data from the Collector can be added to a queue and fed into a data store.

Detector

The Detector calculates a risk score for Blockchain addresses.

In an example implementation, the following is example input data for the Detector: (1) from the Blockchain: Tx, Trace, logs (by the Collector); (2) from the Internet: address intelligence (from the Intelligence Warehouse); and (3) from research/automated learning: patterns (or models).

In this example implementation, the Detector includes a Detection Engine. The Detection Engine loads (and translates) patterns into an internal data structure (DS). The Detection Engine applies all loaded patterns on a Tx (e.g., as the Tx is being broadcast to the network). When a matching pattern is detected, the Detection Engine then updates the risk score of the address in the Tx.

In an example implementation, the following is example input data for the Detector: (1) calculated risk score of addresses (and store score in DB); and (2) the risk score is pushed to the Oracle service. For immediate Oracle access, the address to risk score mapping can be updated on the Oracle's storage. For a request-response Oracle access: Oracle service can query the risk score datastore/database.

An example input data structure for the detector component (e.g., detection engine), which contains all of the information about one block that is stored on the blockchain, is provided below.

```
{′number′: 2000000,
‘hash’: ‘0xc38853328f753c455edaa4dfc6f62a435e05061beac136c13dbdcd0ff38e5f40’,
‘timestamp’: 1470173578,
‘transactions’: [
  {‘from’: ‘0xA1E4380A3B1f749673E270229993eE55F35663b4’,
    ‘to’: ‘0x5DF9B87991262F6BA471F09758CDE1c0FC1De734’,
    ‘input’: 0x,
    ‘gas’: 21000,
    ‘maxFeePerGas’: 20000000,
    ‘maxPriorityFeePerGas’: 1000000000,
    ‘nonce’: 3,
    ‘value’: 31337,
    ‘logs’: [
          { ‘address’: ‘0xf4877805568f5c9a8600048ef198bff99fb01971’,
            ‘data’:
′0x0000000000000000000000000000000000000000000539e22b0080250ac5e1e3000000000000
0000000000000000000000000000000052041d8db717cfad0ad0′,
            ′log_index′: ′2′,
            ′topic0′:
′0x1c411e9a96e071241c2f21f7726b17ae89e3cab4c78be50e062b03a9fffbbad1′,
            ′topic1′: None,
            ′topic2′: None,
            ′topic3′: None,
                  ......
          },
          ......
          ]
  },
  ......
  ]
......
}
```

An example of output (e.g., an alert) for the detector component (e.g., detection engine) is provided below:

```
{
          “txhash”:
“0x958236266991bc3fe3b77feaacea120f172c0708ad01c7a715b255f218f9313c”,
          “addr”: “0x7b792e49f640676b3706d666075e903b3a4deec6”,
          “blocknumber”: 14972419,
          “type”: “tornado funded flashloan”
}
```

The following is an example of patterns to match for risks by the detection engine. This particular pattern contains two events (e.g., that happen in sequence). Event A: an address received tokens from a ‘mixer” service (e.g., the purpose of this service is to hide the token transfer trails, which would otherwise be visible to everyone). Event B: the same address did a ‘flashloan,’ which is a type of loan (e.g., with no collateral) that the borrowing and repaying actions must be finished within the same transaction.

The following are example transactions that would be deemed high risk. The transactions are all about this address: 0x7b792E49f640676B3706d666075E903B3A4deEc6.
1. In transaction (0x84eelce4dd2aa5113aa7191baaea5f77ac85f6c95cba16135e89b11c272817e5), addr: 0x7b79 received 0.975623 Ether from tornado.cash service.
2. In transaction (0xfb5a4d1aef98458f673f301c2e713613662ad621e8f57065a4da58a6401c0b4d), addr 0x7b79 created a new contract (0xf508c58ce37ce40a40997c715075172691P92e2d) using the Ether previously received from tornado. cash service.
3. In transaction (0x958236266991bc3fe3b77feaacea 120f172c0708adOlc7a715b255f218f9313c), addr 0x7b79 interacts with the newly created contract (0xf508) to launch a flashloan that manipulated certain token price. After doing so, addr 0x7b79 leverages the price change to gain $1.26M.
   These transactions are a real-world hack example causing a Defi project greater than a $5M loss.

Intelligence Warehouse

The Intelligence Warehouse includes a Crawler that can crawl feeds (e.g., Twitter, forums, blogs, such as a Twitter example available at https://twitter.com/peckshield/status/1537383268844072960?ref src=twsrc %5Etfw %7Ctwcamp %5Etweetembed %7Ctwterm %5E1537383268844072960%7Ctwgr %5E %7Ctwcon %5Es1 &ref url=https %3A %2F %2Fwww.inverse.finance %2Fblog %2Fpreview %2Fposts %2Fen-US %2Fjune-16-incident-summary %3FpreviewKey %3Dlorem-ipsum, and a blog example available at https://rekt.news/leaderboard/, etc.) for any information related to the Blockchain address (address).

The Intelligence Warehouse includes an Analyzer that can extract an address (e.g., Blockchain address and related labels from the crawled content), which can then be stored in an Intel datastore/database (DB). Example Labels can include the following: a hack association, a purpose of the address, owner of the address, etc.

Customer-Facing Components

The customer/user-facing component(s) can include an API service component 116 (e.g., implemented as a RESTful API(s)), an Alerting service component (e.g., for generating alerts to users/subscribing entities, such as an alert of a potential transaction with an address that is below a threshold score and/or real-time (RT) alerts on detected/prevented Tx), and a user interface (e.g., a Dashboard that can be implemented as a graphical user interface (GUI)) for interactions/communications with users/entities. As an example, the customer/user-facing components can include a user interface (UI) that facilitates a user being able to configure a Blockchain security detection policy (e.g., risk thresholds, alerting triggers, etc.). As another example, the customer/user-facing components can include a user interface (UI) that facilitates a user being able to provide feedback on detection results (or any annotation).

Another example of a UI is that customers can review the overall security posture of their blockchain project (e.g., all the smart contracts deployed on the blockchain). This posture includes all the (risky) transactions that have interacted with their smart contract and the risk score associated with each transaction.

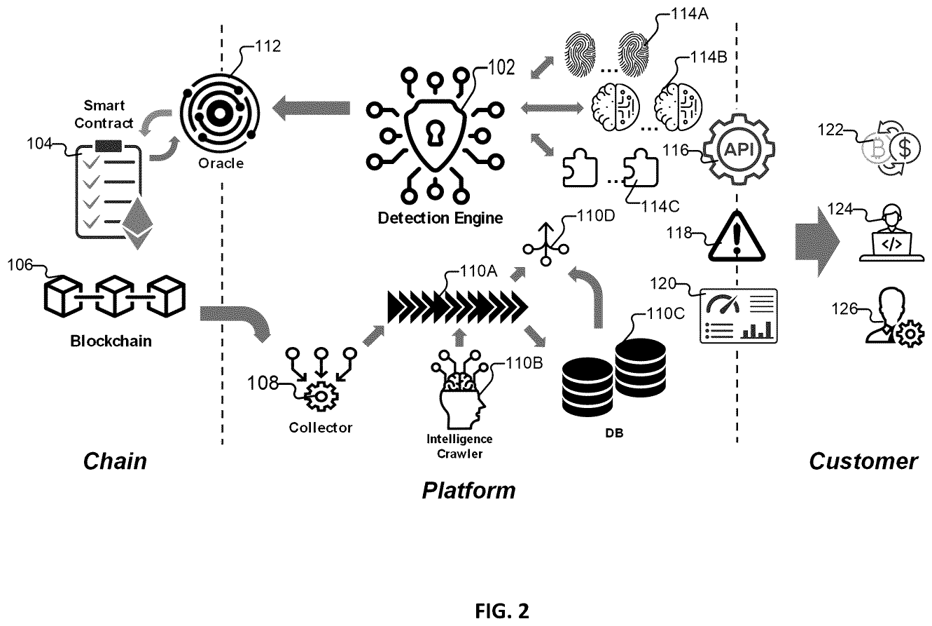

FIG. 2 is another block diagram of an architecture of a threat prevention platform for security detection for blockchains in accordance with some embodiments. FIG. 2 provides more detailed components for the above-described threat prevention platform.

Referring to FIG. 2, the Collector fetches information about the following: a transaction (Tx), trace, logs from the Blockchain as the Tx happens. The fetched information (e.g., from the Collector as shown at 108 and/or the Intelligence Crawler as shown at 110B, which can include an intelligence datastore/DB, such as a Mongo DB or another form of datastore/DB) is provided to a message bus as shown at 110A. The fetched information is then stored in a datastore/database (e.g., SQL database or another form of datastore/DB for storing the fetched information) as shown at 110C (e.g., DB 110C can also include a datastore/DB for storing Tx information, such as an SQL database or another form of datastore/DB). A data aggregator is shown at 110D, which aggregates the on-chain information as well as off-chain info, and sends the aggregated information to different detection modules in Detection Engine 102.

As also shown in FIG. 2, Detection Engine 102 can use signatures 114A for detecting malicious/suspicious transactions and/or malicious/suspicious entities associated with the transaction(s).

Signatures are generated by extracting unique information from known malicious activities. As an example, a signature can be a regex pattern matching a specific malicious Transaction Input data. When a signature is matched, a similar malicious transaction is detected.

The Detection Engine can also use ML models 114B for detecting malicious/suspicious transactions and/or malicious/suspicious entities associated with the transaction(s). For example, the ML model for smart contract behavior can be trained for all interactions with their smart contracts for the Ethereum Blockchain to learn normal behaviors/interactions with their smart contracts to generate/train the ML model for smart contract behavior to learn expected input to such contracts. The generated/trained ML model for smart contract behavior can then be deployed in the threat prevention platform for blockchains to automatically detect anomalous behavior associated with smart contracts for the Ethereum Blockchain.

The Detection Engine can also use heuristics 114C for detecting malicious/suspicious transactions and/or malicious/suspicious entities associated with the transaction(s). For example, heuristics can be implemented in the threat prevention platform for blockchains to further enhance security detection for blockchains based on such smart contract transactions (e.g., input anomaly detection in terms of size, form, or increase in interaction with these functions, as well as the result after interaction with this function, which typically succeeds or fails repeatedly; or outcome/output is different than expected for typical input such as a drain of coin pool, etc.).

Heuristics are generated based on analysis of smart contracts and known security issues/events. As an example, heuristics can be generated by extracting key patterns from malicious/suspicious activities (e.g., including known hacks) on the Blockchain. As another example, heuristics can be generated by extracting known/expected behaviors/functionalities of smart contracts.

The following are examples of the heuristics rules. Each rule describes and detects a specific combination of events (w/ or w/o sequence).

```
100000001″ : {
            ″title″ : ″Torando Hacks ″,
            ″description″ : ″ this alert detected the lifi hacks″,
            ″severity″: ″critical″,
            ″confidence″: ″high″,
            ″correlation″ : {
                  ″key″ : ″addr″,
                  ″signal″ : [
                        {
                        ″equal″ : {
                              ″event″ : ″13″
                              },
                        ″match″ : {
                              ″provider″ : ″aave″ ,
                              ″borrower″ :
″0x78c94b6510fe5d2034c024e981fe5454a5cle2d6″
                              },
                        ″greater″ : {″amount″ : ″10000″},
                        ″count″ : ″2″
                        },
                        {
                        ″match″ : {
                              ″borrower″ :
″0x78c94b6510fe5d2034c024e981fe5454a5c1e2d6″
                              },
                        ″equal″ : {
                              ″event″ : ″7″
                              }
                        },
                  { ″match″ : {
                        ″token″ : ″WETH”
                          },
                  ″equal″ : {
                        ″event″ : ″122″
                        }
                  }
                  ]
            },
  ″300000001″ : {
            ″title″ : ″Tornado $$ + Flashloan″,
            ″description″ : ″The detected addresses that receive
$$ from tornado.cash, then do flashloan″,
            ″unit-testing″ : {
                  ″block″: [ ]
                  },
            ″severity″: ″critical″,
            ″confidence″: ″high″,
            ″correlation″ : {
                  ″key″ : ″addr″,
                  ″signal″ : [
                        {
                        ″equal″ : {
                              ″event″ : ″101″
                              },
                        ″greater″ : { ″amount″ : ″8″ }
                        },
                        {
                        ″equal″ : {
                              ″event″ : ″112″
                              },
                        ″match″ : {
                              ″type″ : ″receive″
                        }
                  }
                  ]
            },
}
```

As will now be apparent to one of ordinary skill in the art, the above-described threat prevention platform for security detection for blockchains can facilitate detection/prevention of security for blockchains as a service (e.g., as a subscription service).

In addition, the above-described techniques can similarly be deployed via an integration with Smart Contract (SC) source code to detect/prevent high risk transactions (Tx). For example, such an integration can support user annotation on expected behavior of the given SC.

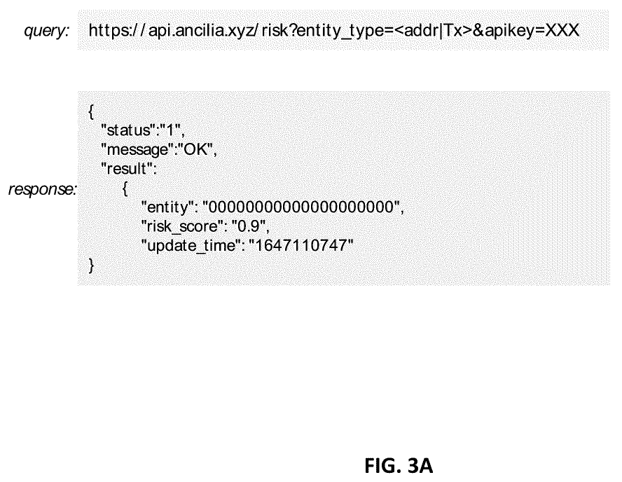

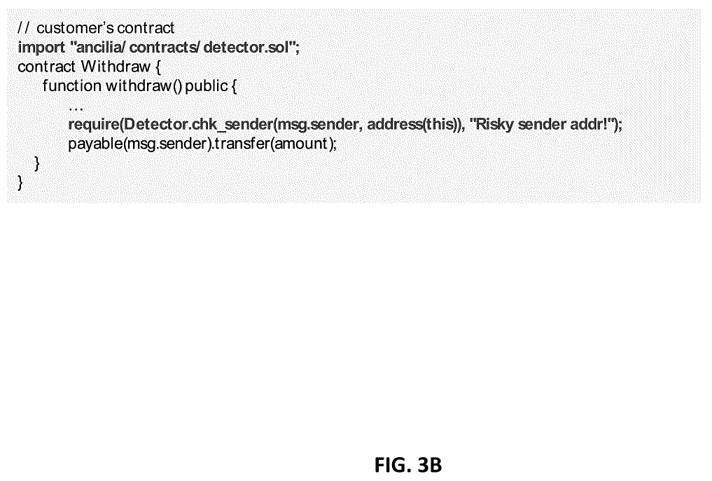

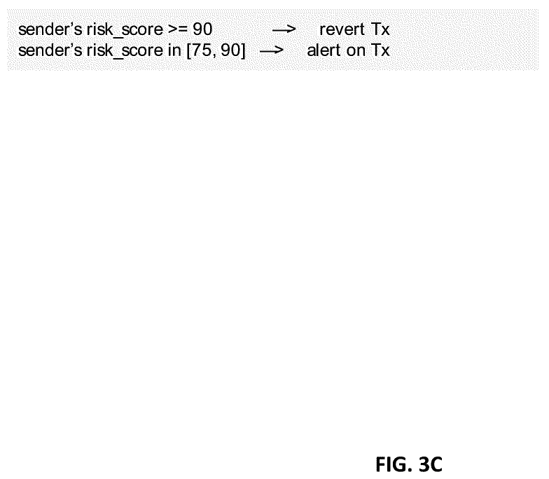

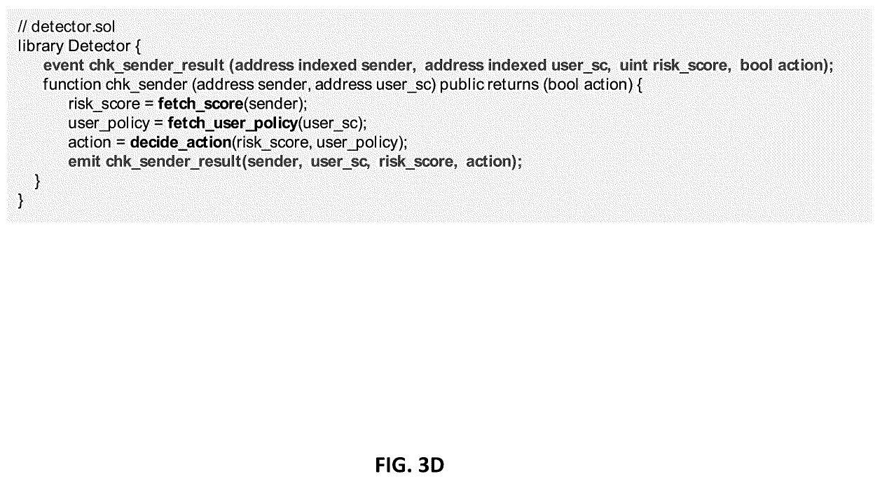

FIG. 3A is pseudocode of an example workflow for an API service for security detection for blockchains in accordance with some embodiments. Specifically, FIG. 3A is pseudocode of a standard workflow for the API service in JSON.

FIG. 3B is pseudocode for an integration into Smart Contract source code in accordance with some embodiments. For example, integration into a customer's Smart Contract source code (e.g., by the developer) can be implemented using various options. First, the Smart Contract can be programmed to import a library (lib) and perform a check in a critical function to call our Oracle contract (e.g., an Oracle contract associated with the threat prevention platform for security detection on blockchains). Second, the Smart Contract can be programmed to call a function (func) modifier, which can be applied on critical funcs, which calls our Oracle contract before the function is executed.

FIG. 3C is pseudocode for a customer setup detection policy (via a Dashboard) in accordance with some embodiments. As shown in this example Blockchain security detection policy for a given customer, if a sender's risk score exceeds a threshold of 90, then the threat prevention platform is configured to revert/allow the transaction (Tx). However, if a sender's risk score is below 90 but exceeds a threshold of 75, then the threat prevention platform is configured to alert on the transaction (Tx).

FIG. 3D is pseudocode for the Detector to perform an action based on a Blockchain security detection policy in accordance with some embodiments. In this example, the Detector will emit events, such as an event (Tx sender, contract, risk score, action), in which the “action” is based on a user defined policy, such as similarly described above. In an example implementation of a threat prevention platform for security detection for Blockchains, our client can listen and collect these events, and send to our platform, which will be presented to customers using the above-described customer-facing components.

As will now be apparent, blockchain transactions can be monitored/filtered using one or more security platforms to facilitate security detection for blockchains.

Example Use Cases of Enhanced Security for Blockchains

The disclosed techniques for providing enhanced security for blockchains can be applied in a variety of additional example use case scenarios for facilitating security detection for blockchain as will now be described with respect to various example use cases.

As a first example use case, the disclosed techniques can be used to facilitate security detection for blockchains for the following example smart contract:

The following smart contract (“0x939bd8d64c0a9583a7dcea9933f7b21697ab6396”) which is a timelock that can execute transactions submitted from an admin account in a delayed fashion.

Part of the expected behavior of this smart contract is changing the admin address. This is a privileged operation and, hence, must be first initiated by the current admin who proposed a pending admin address, then accepted by the pending admin. The entire process requires two transactions (Tx) in that order.

With this understanding of the expected behavior, our system (e.g., threat prevention platform as described above) encountered the following Tx From “0xeaeb31370e9bbc912d1de71 bf59bba89886fcfcb” to the SC (“0x939b”) at https://www.bscscan.com/tx/Oxf4cb2df56b438ffb190b367014ca877cfbefbcOdad6e32cde9c0e9ea dd9dc97d, which is trying to invoke the following function on the SC (“0x939b”) (i.e., “Function: acceptAdmin( ) MethodID: 0x0e18b681).

The disclosed techniques for security detection for blockchains can identify this as an abnormal transaction (Tx), because there was no prior proposal from the current admin address to change admin to the “0xeaeb” address.

As another example use case, the disclosed techniques for security detection for blockchains can be used to detect the abnormal behaviors caused by smart contract vulnerabilities. This example smart contract (0x20E5E35ba29dC3B540a1aee781D0814D5c77Bce6) has a function “depositETH”, which uses an internal parameter “ResourceID”. “ResourceID” was originally set to the value of “0x2f422fe9ea622049d6f73f81a906b968cff03b7f01”. During a code upgrade, developers made a mistake and updated the “ResourceID” from its original value to “0x0”.

As a result of the mistake in an upgrade, when a transaction invoked the “deposit” function of the smart contract (0x20E5E35ba29dC3B540a1aee781D0814D5c77Bce6), the transaction will only emit one “deposit” log. As a comparison, before the upgrade (i.e., code is correct), when a transaction invoked the “deposit” function, it will emit two logs: a “transfer” log and a “deposit” log.

The disclosed threat prevention platform for providing security detection for blockchains (e.g., our system) continuously monitors the transactions with the smart contract (0x20E5E35ba29dC3B540a1aee781D0814D5c77Bce6) and learns the expected output of invoking the “deposit” function should include two logs (“transfer” and “deposit” respectively). With this learning, when our system encounters the first transaction (https://etherscan.io/tx/0x5af141b2c19cc8cb77a5583654575a6811664ebc304b75e687a6e356b7d d7cf7) that invoked the “deposit” function after the upgrade, our system can identify the anomaly and send alerts to the blockchain project team. As a result, the blockchain project team will have a chance to fix their prior mistake.

As will now be apparent to one of ordinary skill in the art, the disclosed techniques for security detection for blockchains using a security platform for security policy enforcement can be applied in a variety of additional example use case scenarios to detect/prevent these and other types of attacks for facilitating enhanced security for blockchains.

Additional example processes for the disclosed techniques for security detection for blockchains will now be described.

Example Processes for Security Detection for Blockchains

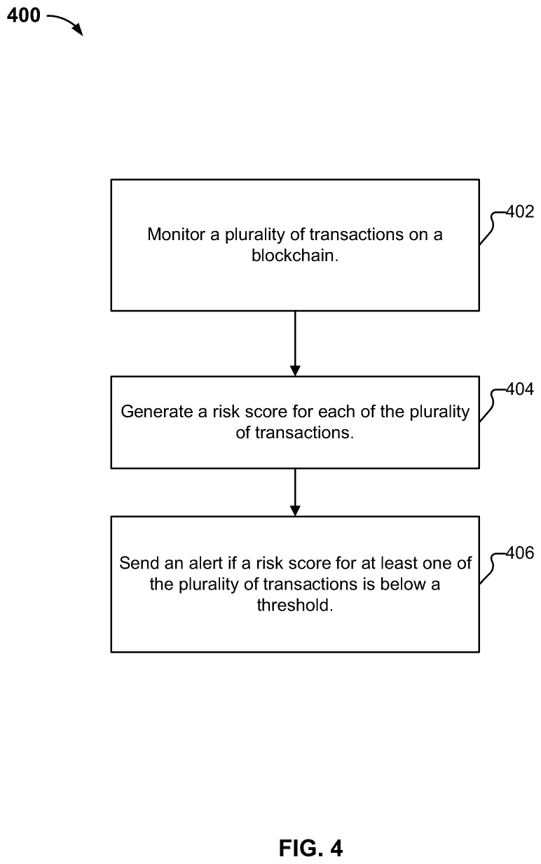

FIG. 4 is a flow diagram of a process for security detection for blockchains in accordance with some embodiments. In some embodiments, a process 400 as shown in FIG. 4 is performed by the security platform and techniques as similarly described above including the embodiments described above with respect to FIGS. 1-3D.

At 402, monitoring a plurality of transactions on a blockchain is performed. For example, the threat prevention platform for providing security detection for blockchains as similarly described above with respect to FIGS. 1-3D can be used for monitoring the plurality of transactions on the blockchain.

At 404, generating a risk score for each of the plurality of transactions is performed. For example, the Detection Engine component of the threat prevention platform for providing security detection for blockchains as similarly described above with respect to FIGS. 1-3D can be used for generating the risk score for each of the plurality of transactions. As also similarly described above, the risk score can be based on a signature, a heuristic, and/or an ML model that is trained for detecting risky/malicious transactions on the blockchain project.

At 406, an alert is sent if a risk score for at least one of the plurality of transactions is below a threshold. For example, the UI/alerting component of the threat prevention platform for providing security detection for blockchains as similarly described above with respect to FIGS. 1-3D can be used for sending the alert if the risk score for at least one of the plurality of transactions is below the threshold.

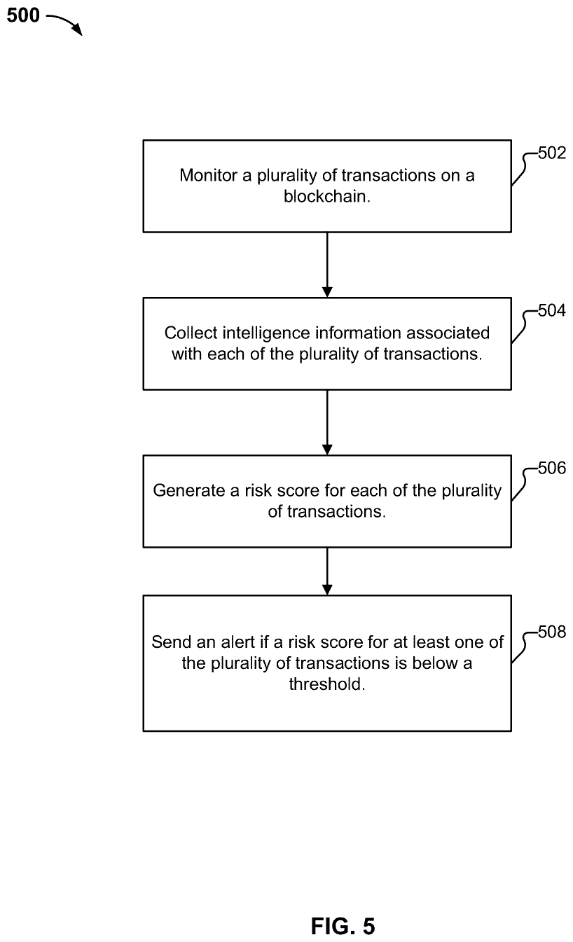

FIG. 5 is another flow diagram of a process for security detection for blockchains in accordance with some embodiments. In some embodiments, a process 500 as shown in FIG. 5 is performed by the security platform and techniques as similarly described above including the embodiments described above with respect to FIGS. 1-3D.

At 502, monitoring a plurality of transactions on a blockchain is performed. For example, the threat prevention platform for providing security detection for blockchains as similarly described above with respect to FIGS. 1-3D can be used for monitoring the plurality of transactions on the blockchain.

At 504, intelligence information associated with each of the plurality of transactions is collected. For example, the Collector and Intelligence Crawler components of the threat prevention platform for providing security detection for blockchains as similarly described above with respect to FIGS. 1-3D can be used for collecting intelligence information associated with each of the plurality of transactions.

At 506, generating a risk score for each of the plurality of transactions is performed. For example, the Detection Engine component of the threat prevention platform for providing security detection for blockchains as similarly described above with respect to FIGS. 1-3D can be used for generating the risk score for each of the plurality of transactions. As also similarly described above, the risk score can be based on a signature, a heuristic, and/or an ML model that is trained for detecting risky/malicious transactions on the blockchain project.

At 508, an alert is sent if a risk score for at least one of the plurality of transactions is below a threshold. For example, the UI/alerting component of the threat prevention platform for providing security detection for blockchains as similarly described above with respect to FIGS. 1-3D can be used for sending the alert if the risk score for at least one of the plurality of transactions is below the threshold.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system, comprising:
a processor of a threat prevention platform configured to:
monitor a plurality of transactions on a blockchain;
generate a risk score for each of the plurality of transactions using the threat prevention platform; and
send an alert if a risk score for at least one of the plurality of transactions is below a threshold; and
a memory coupled to the processor and configured to provide the processor with instructions.

2. The system recited in claim 1, wherein the threat prevention platform performs threat prevention for the blockchain.

3. The system recited in claim 1, wherein the threat prevention platform is configured with a plurality of blockchain security policies.

4. The system recited in claim 1, wherein the plurality of transactions on the blockchain include smart contract transactions.

5. The system recited in claim 1, wherein the processor is further configured to:
detect a malicious transaction on the blockchain.

6. The system recited in claim 1, wherein the processor is further configured to:
detect a malicious transaction on the blockchain based on a signature match.

7. The system recited in claim 1, wherein the processor is further configured to:
detect a malicious transaction on the blockchain based on a heuristic match.

8. The system recited in claim 1, wherein the processor is further configured to:
detect a malicious transaction on the blockchain based on a machine learning (ML) model.

9. The system recited in claim 1, wherein the processor is further configured to:
generate an alert for a smart contract transaction based on the risk score for the smart contract transaction and a blockchain security policy.

10. The system recited in claim 1, wherein the processor is further configured to:
revert a smart contract transaction based on a score for the smart contract transaction and a blockchain security policy.

11. A method, comprising:
monitoring a plurality of transactions on a blockchain;
generating a risk score for each of the plurality of transactions using a threat prevention platform; and
sending an alert if a risk score for at least one of the plurality of transactions is below a threshold.

12. The method of claim 11, wherein the threat prevention platform performs threat prevention for the blockchain.

13. The method of claim 11, wherein the threat prevention platform is configured with a plurality of blockchain security policies.

14. The method of claim 11, wherein the plurality of transactions on the blockchain include smart contract transactions.

15. The method of claim 11, further comprising:
detecting a malicious transaction on the blockchain.

16. The method of claim 11, further comprising:
detecting a malicious transaction on the blockchain based on a signature match.

17. The method of claim 11, further comprising:
detecting a malicious transaction on the blockchain based on a heuristic match.

18. The method of claim 11, further comprising:
detecting a malicious transaction on the blockchain based on a machine learning (ML) model.

19. The method of claim 11, further comprising:
generating an alert for a smart contract transaction based on the risk score for the smart contract transaction and a blockchain security policy.

20. The method of claim 11, further comprising:
reverting a smart contract transaction based on a score for the smart contract transaction and a blockchain security policy.

21. A computer program product, the computer program product being embodied in a non-transitory computer readable storage medium and comprising computer instructions for:
monitoring a plurality of transactions on a blockchain;
generating a risk score for each of the plurality of transactions using a threat prevention platform; and
sending an alert if a risk score for at least one of the plurality of transactions is below a threshold.
